(19) United States
(12) Patent Application Publication
(10) Pub. No.: US 2014/0013720 A1
(43) Pub. Date: Jan. 16, 2014

(54) DUST FILTER MOUNTING APPARATUS

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: RI-DONG HUANG, Shenzhen (CN); GUANG-YAO LEE, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/707,967

(22) Filed: Dec. 7, 2012

(30) Foreign Application Priority Data
Jul. 12, 2012 (CN) 2012102403629

(51) Int. Cl. B01D 46/00

(52) U.S. Cl. CPC B01D 46/0005
USPC 55/480

(57) ABSTRACT

A dust filter mounting apparatus includes a side plate, a dust filter, and a latching member. The side plate includes a main plate defining a receiving recess, and a sidewall defining an opening communicating with the receiving recess. A resilient member is formed in the receiving recess. The dust filter is extended through the opening and slidably received in the receiving recess. A block is formed on the dust filter. The latching member is mounted to the main plate and includes a latch extending into the receiving recess and engaging with the block. When the dust filter is pressed into the receiving recess, the dust filter pushes the latching member to slide backward and away from the sidewall, the resilient member is deformed, and the latch disengages from the block, then the resilient member is restored to push the dust filter to slide partially out of the opening.

### BACKGROUND

1. Technical Field

The present disclosure relates to an apparatus for mounting a dust filter.

2. Description of Related Art

A dust filter is usually mounted to a sidewall of an electronic device. Typically, the dust filter is inserted into a receiving slot defined in the sidewall from an opening defined in an end of the sidewall. A notch is defined in the end of the sidewall communicating with the opening, to facilitate pulling out of the dust filter. However, it is troublesome to insert a finger into the notch to pull out of the dust filter, and the notch will affect aesthetics of the whole exterior of the electronic device.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a dust filter mounting apparatus.

FIG. 2 is a partially assembled, isometric view of FIG. 1.

FIG. 3 is an assembled, isometric view of FIG. 1.

FIG. 4 is a cross-sectional view taken along the line IV-IV of FIG. 3.

FIG. 5 is similar to FIG. 4, but showing the dust filter mounting apparatus in a different state.

FIG. 6 is a cross-sectional view taken along the line VI-VI of FIG. 3 in a different state.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

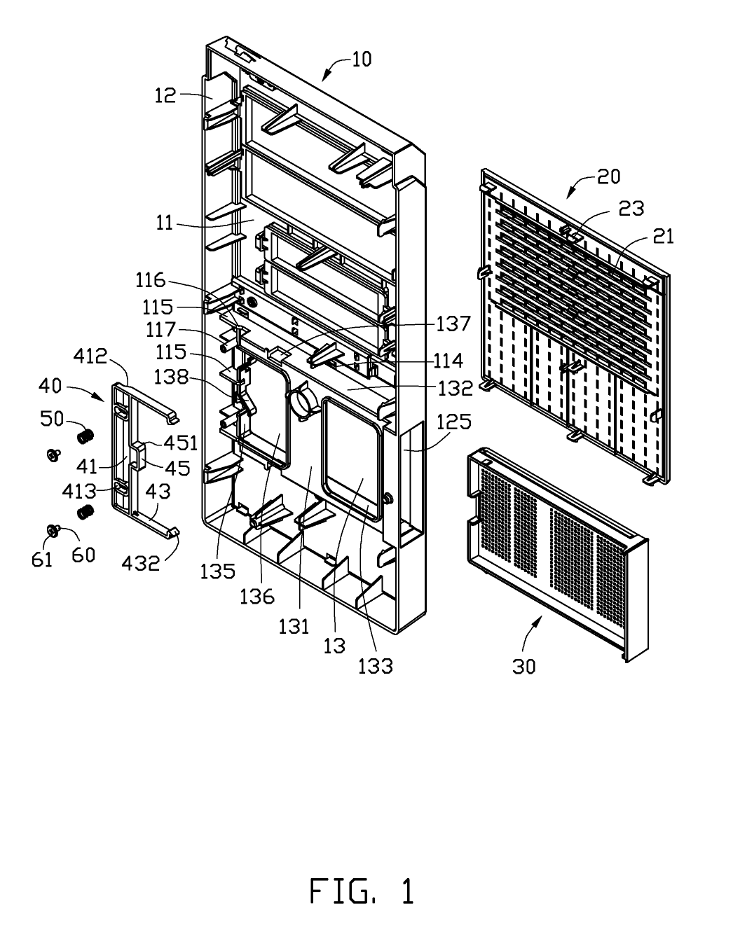

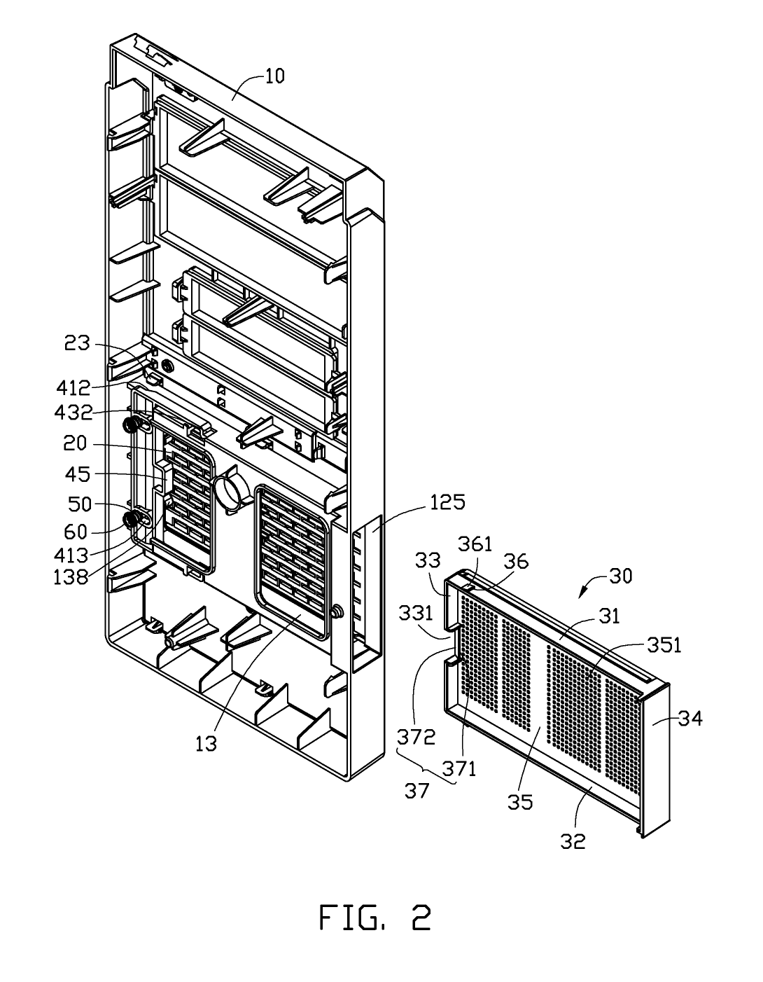

FIGS. 1, 2, and 5 show an exemplary embodiment of a dust filter mounting apparatus. The dust filter mounting apparatus includes a side plate 10, a cover 20, a dust filter 30, a latching member 40, two elastic members 50, and two fasteners 60. In one embodiment, the elastic members 50 are springs, and the fasteners 60 are screws.

In one embodiment, the side plate 10 is a bezel of an electronic device. The side plate 10 includes a main plate 11 and two sidewalls 12 extending backward from opposite sides of the main plate 11. A middle of the main plate 11 is concaved backward to form a receiving recess 13. The receiving recess 13 includes a rear wall 131 parallel to the main plate 11, a top wall 132 perpendicularly connected between the main plate 11 and the top of the rear wall 131, a bottom wall 133 perpendicularly connected between the main plate 11 and the bottom of the rear wall 131, and an end wall 135 perpendicularly connected between the top wall 132 and the bottom wall 133, adjacent to one of the sidewalls 12. A plurality of vents 136 is defined in the rear wall 131. One of the vents 136, adjacent to the end wall 135, extends through the rear side of the end wall 135. A through hole 137 is defined in each of the top wall 132 and the bottom wall 133, communicating with the receiving recess 13. A substantially V-shaped resilient member 138 splaying toward the receiving recess 13 protrudes from a middle of the end wall 135. An opening 125 is defined in the other sidewall 12, away from the end wall 135, aligning and communicating with the receiving recess 13. A plurality of slots 114 is defined in the main plate 11, around the receiving recess 13. A plurality of longitudinally spaced supporting tabs 115 is formed on the rear side of the main plate 11, connected between the end wall 135 and the sidewall 12. A rear corner of each supporting tab 115 adjacent to the end wall 135 is cut out to form a first slanted surface 116, slantingly extending forward towards the receiving recess 13. Two longitudinally spaced fixing poles 117 protrude backward from the rear side of the main plate 11, between the supporting tabs 115.

The cover 20 defines a plurality of heat dissipation holes 21. A plurality of hooks 23 protrudes from four sides of the rear surface of the cover 20.

The dust filter 30 includes a top plate 31, a bottom plate 32, a first end plate 33, a second end plate 34, and a dust screen 35. The first end plate 33 is connected between first ends of the top plate 31 and the bottom plate 32. The second end plate 34 is connected between second ends of the top plate 31 and the bottom plate 32. The dust screen 35 is connected to middle of the top plate 31, the bottom plate 32, and the first and second end plates 33 and 34. The dust screen 35 defines a plurality of holes 351. A wedge-shaped protrusion 36 is formed on an outer surface of each of the top plate 31 and the bottom plate 32, adjacent to the first end plate 33. Each protrusion 36 includes a first guide surface 361 slantingly extending down toward the first end plate 33. A notch 331 is defined in a middle of the first end plate 33, behind the dust screen 35, and extending through the rear side of the first end plate 33. A block 37 is formed on the first end plate 33, in front of the notch 331. The block 37 includes an engaging surface 371 facing the second end plate 34 and perpendicular to the dust screen 35, and a second guide surface 372 facing away from the second end plate 34 and slanting forward in a direction away from the second end plate 34.

The latching member 40 includes a substantially rectangular main body 41, and two arms 43 extending from opposite ends of a side of the main body 41 in a perpendicular manner. A side of the front surface of the main body 41 away from the arms 43 is cut out to form a longitudinally extending second slanted surface 412. The second slanted surface 412 slants forward towards the arms 43. Two elongated widthwise extending through slots 413 are defined in the main body 41. A latch 45 protrudes from a middle of the side of the main body 41 facing the arms 43. A latching portion 451 extends forward from a distal end of the latch 45 away from the main body 41. A hook 432 is formed on a distal end of each arm 43, and extends toward the opposite arm 43.

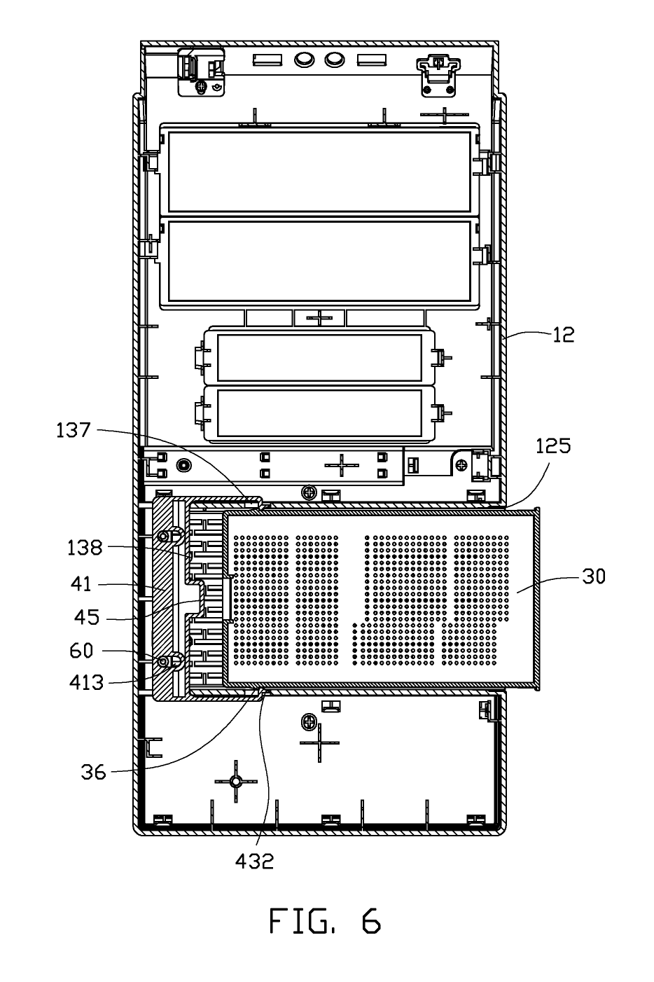

In assembly, the cover 20 is mounted to the front side of the main plate 11, to allow the hooks 23 to respectively engage in the slots 114. Thereby, the front side of the receiving recess 13 is blocked by the cover 20. The latching member 40 is arranged on the rear side of the side plate 10, to allow the second slanted surface 412 to engage with the first slanted surfaces 116, and to allow the fixing poles 117 to slidably extend through the through slots 413 respectively. The fixing poles 117 abut against portions of the main body 41 bounding ends of the through slots 413 away from the latch 45. The latch 45 and the side of the main body 41, adjacent to the latch 45, extend into the receiving recess 13 and are arranged behind the resilient member 138. Compared with a distal end of the resilient member 138, the latch 45 is closer to the opening 125 (see FIG. 6). The arms 43 are respectively arranged at the outsides of the top wall 132 and the bottom wall 133, with the hooks 432 respectively extending into the through holes 137. The elastic members 50 are respectively placed around the rear portions of the poles 117. The fasteners 60 are respectively engaged in the rear ends of the poles 117, to allow the elastic members 50 to be sandwiched between a rear side of the main body 41 and heads 61 of the fasteners 60. Thereby, the latching member 40 is slidably mounted to the rear side of the side plate 10.

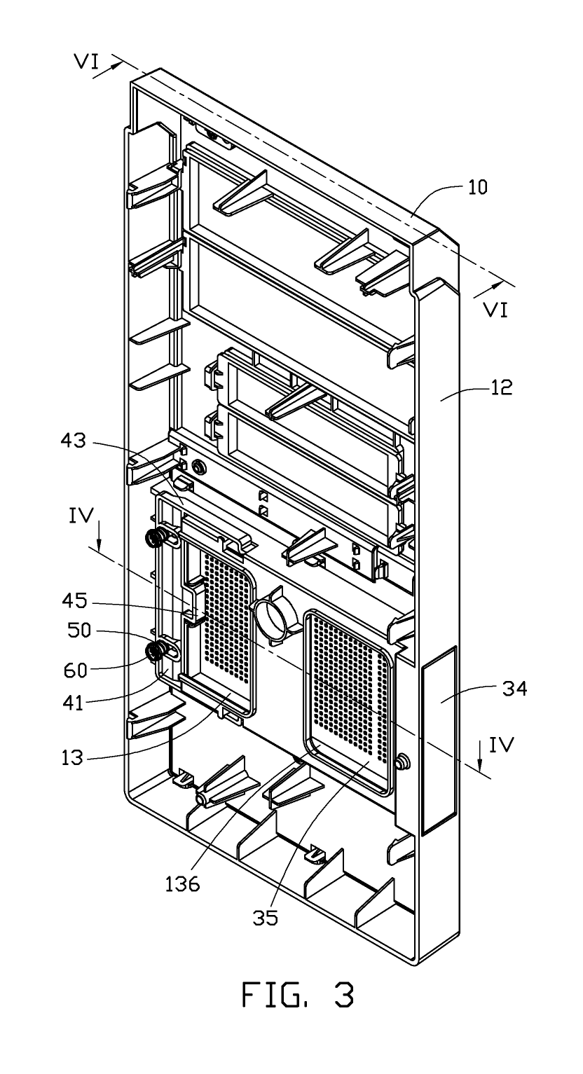

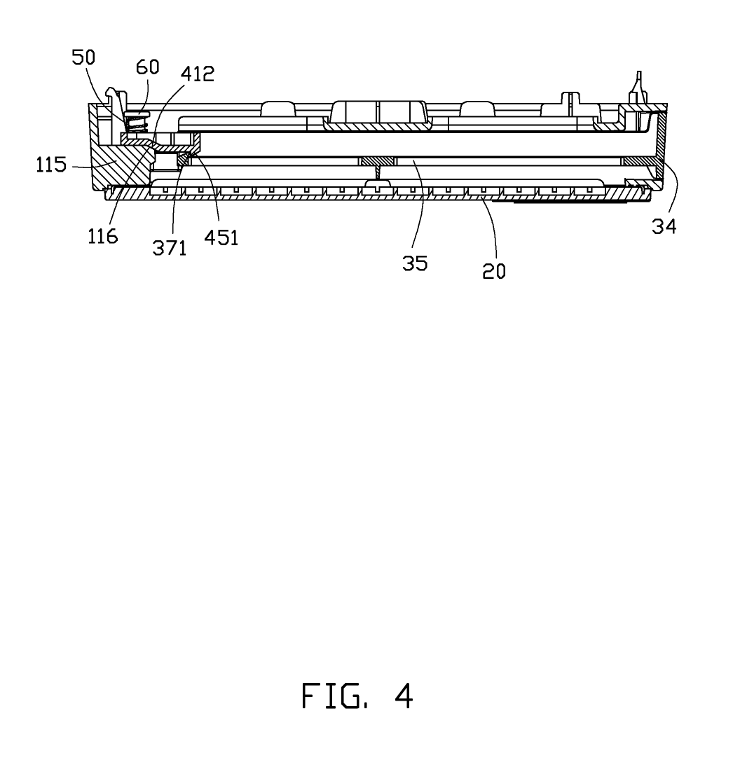

FIGS. 3 and 4 show that the first end plate 33 is extended through the opening 125 and inserted into the receiving recess 13. The dust filter 30 is pushed towards the resilient member 138. The first guide surfaces 361 respectively abut against the hooks 432 to deform the hooks 432 outwards. After the protrusions 36 pass over the hooks 432, the hooks 432 are restored. The dust filter 30 is further pushed into the receiving recess 13. The second guide surface 372 abuts against a distal end of the latching portion 451, and pushes the latching member 40 to slide backward along the first slanted surfaces 116. The elastic members 50 are compressed. After the block 37 passes over the latching portion 451, the elastic members 50 are restored to push the latching member 40 to slide forward along the first slanted surfaces 116. The latching portion 451 engages with the engaging surface 371. Thereby, the dust filter 30 is locked by the latching member 40. The dust filter 30 is completely received in the receiving recess 13, with the second end plate 34 received in the opening 125 and coplanar with the sidewall 12 defining the opening 125. The first end plate 33 abuts the side of the main body 41 facing the latch 45.

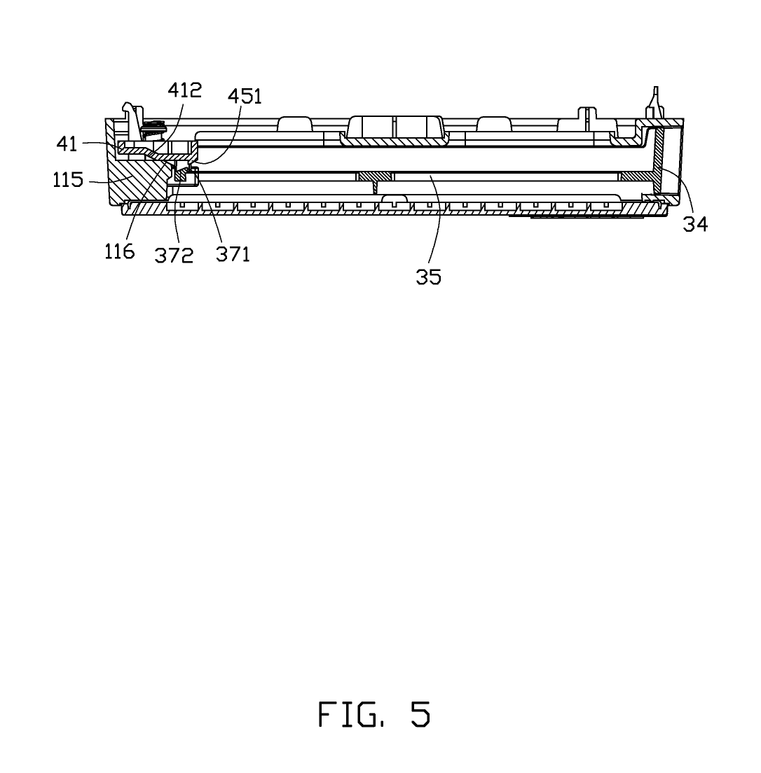

FIG. 5 shows that to detach the dust filter 30 from the side plate 10, the second end plate 34 is pressed into the receiving recess 13, to allow the dust filter 30 to move toward the resilient member 138. The first end plate 33 pushes the main body 41 and the resilient member 138, to allow the latching member 40 to slide backward along the first slanted surfaces 116. The resilient member 138 is deformed. The elastic members 50 are compressed. The second slanted surface 412 is staggered with the first slanted surfaces 116. The first end plate 33 further pushes the main body 41, to allow the main body 41 to slide away from the opening 125 along the rear sides of the supporting tabs 115, until the fixing poles 117 abut against portions of the main body 41, bounding opposite ends of the through slots 413 adjacent to the latch 45. The latching portion 451 disengages from the engaging surface 371. The resilient member 138 is further deformed.

FIG. 6 shows that the second end plate 34 is released, and the resilient member 138 is restored to push the dust filter 30 towards the opening 125. The second end plate 34 extends out of the opening 125. The second end plate 34 is pulled away from the resilient member 138 by a user. The protrusions 36 respectively abut against the hooks 432, and pull the latching member 40 together with the arms 43 to slide towards the opening 125, until the fixing poles 117 abut against the portions of the main body 41 bounding ends of the through slots 413 away from the latch 45. The latching member 40 is returned to its original position, where the first slanted surfaces 116 engage with the second slanted surface 412, the elastic members 50 are restored. The dust filter 30 is further pulled out. The protrusions 36 further abut against the hooks 432, to deform the hooks 432 outward, until the protrusions 36 pass over the hooks 432. The hooks 432 are restored. Thereby, the dust filter 30 can be completely pulled out of the side plate 10.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A dust filter mounting apparatus, comprising:
a side plate comprising a main plate and a sidewall, extending backward from a side of the main plate; wherein a receiving recess is defined in the main plate, an opening is defined in the sidewall communicating with the receiving recess, and a resilient member is formed in the receiving recess;
a dust filter extending through the opening and slidably received in the receiving recess; wherein a block is formed on the dust filter; and
a latching member mounted to a rear side of the main plate at an original position and capable of sliding backward and away from the sidewall; wherein the latching member comprises a latch extending into the receiving recess and engaging with the block of the dust filter;
wherein when the dust filter is pressed into the receiving recess, the dust filter pushes the latching member to slide backward and away from the sidewall, the resilient member is deformed, and the latch disengages from the block, then the resilient member is restored to push the dust filter to slide partially out of the opening.

2. The dust filter mounting apparatus of claim 1, wherein a plurality of supporting tabs is formed on the rear side of the main plate away from the sidewall, and each supporting tab forms a first slanted surface extending forward towards the sidewall; the latching member further comprises a main body movably mounted to rear sides of the plurality of supporting tabs; a front surface of the main body forms a second slanted surface slanting forward towards the sidewall; and the second slanted surface engages with the first slanted surfaces and is capable of sliding backward along the first slanted surfaces.

3. The dust filter mounting apparatus of claim 2, further comprising two elastic members and two fasteners; wherein two elongated through slots are defined in the main body of the latching member, extending in a direction perpendicular to the sidewall; two fixing poles protrude backward from the rear side of the main plate, and slidably extend through the two through slots in the direction perpendicular to the sidewall; the two elastic members are respectively placed around rear portions of the two fixing poles; and the two fasteners respectively engage in rear ends of the two fixing poles, to sandwich the two elastic members between the two fasteners and a rear side of the main body.

4. The dust filter mounting apparatus of claim 1, wherein the latching member further comprises two arms respectively arranged at outsides of a top and a bottom of the receiving recess; each arm forms a hook extending into the receiving recess; a protrusion is formed on an outer surface of each of a top and a bottom of the dust filter; and after the resilient member pushes the dust filter to slide partially out of the opening, the dust filter is pulled out of the receiving recess, the two protrusions of the dust filter abut against the two hooks of the two arms and pull the latching member to slide towards the opening to the original position.

5. The dust filter mounting apparatus of claim 4, wherein each of the two protrusions forms a guide surface facing away from the opening, and the two protrusions are capable of passing over the two hooks of the two arms towards and away from the opening.

6. The dust filter mounting apparatus of claim 1, wherein the resilient member is substantially V-shaped, protrudes from a middle of an end of the receiving recess away from the opening, and splays towards the opening.

7. The dust filter mounting apparatus of claim 1, wherein the dust filter comprises a first end plate and a second end plate opposite to the first end plate, the block is formed on the first end plate; and when the latch of the latching member engages with the block, the second end plate is received in the opening and coplanar with the sidewall.

8. The dust filter mounting apparatus of claim 1, further comprising a cover defining a plurality of heat dissipation holes; and wherein the receiving recess is concaved backward from the main plate, and the cover is mounted to a front side of the main plate and blocks a front side of the receiving recess.

9. The dust filter mounting apparatus of claim 1, wherein at least one vent is defined in a rear side of the receiving recess.
